(19) United States
(12) Patent Application Publication
(10) Pub. No.: US 2016/0096919 A1
(43) Pub. Date: Apr. 7, 2016

(54) METHOD FOR PREPARING A POLYESTER

(71) Applicant: SAUDI BASIC INDUSTRIES CORPORATION, Riyadh (SA)

(72) Inventors: Miloud BOUYAHYI, GELEEN (NL); Robbert DUCHATEAU, GELEEN (NL); Lidia JASINSKA-WALC, GELEEN (NL)

(21) Appl. No.: 14/890,772

(22) PCT Filed: May 20, 2014
(86) PCT No.: PCT/IB2014/061561

§ 371 Date: Nov. 12, 2015

(30) Foreign Application Priority Data
May 23, 2013 (EP) 13002690.9

(51) Int. Cl. C08G 63/83; C08G 63/08; C08G 63/84

(52) U.S. Cl. CPC C08G 63/83; C08G 63/84; C08G 63/08

(57) ABSTRACT

The invention is directed to a method for preparing a polyester comprising providing a first cyclic ester having a ring size of from 12-40 atoms and subjecting the first cyclic ester to ring-opening polymerisation by contacting the first cyclic ester with a catalyst of formula I.

### BACKGROUND

The present invention relates to a method for preparing a polyester homopolymer or a polyester copolymer.

Polyesters are interesting materials because of their properties which, for instance, include biocompatibility, biodegradability, and drug permeability. In addition they may exhibit preferred barrier properties, in particular oxygen barrier properties, when used in film applications. Therefore, polyesters are of great interest for medical and food packaging applications. For these purposes materials with an engineered structure are desired, which implies the need for a high level of control over the polymerisation reaction. In addition, with the right properties, certain polyesters can form an interesting biodegradable alternative for polyethylene in various applications.

Traditional polyester synthesis strategies, using e.g. polycondensation, give rise to fundamental problems that can make the controlled synthesis of these materials a tedious process. For example, the preparation of polyesters by polycondensation can be accompanied by stoichiometric problems, the need for high conversion and the removal of small molecules formed during the reaction. A suitable replacement for these conventional strategies is the ring-opening polymerisation of cyclic esters, in particular of lactones. This polymerisation is based on the fact that cyclic monomers “open up” and form a polymer chain by means of a chain-growth process. However, ring-opening polymerisation reactions can also be difficult to control, in particular when anionic or cationic initiators are used. It is known that ring-opening polymerisation reactions can be performed with enzymes with satisfactory conversion under mild polymerisation conditions. For example, lipases such as Candida Antarctica Lipase B (CALB) are highly active in the ring-opening polymerisation of lactones and show exceptionally high polymerisation rates for lactones having a relatively large ring size. The reactivity of lactones in this process is not governed by the high ring-strain of small lactones but by the preference of the lipase for transoid ester bond conformation present in large ring lactones. Macrolactones can thus easily be polymerized by CALB. For example, poly-pentadecalactone (PPDL) with a number average molecular weight up to 150000 g/mol has been reported (Focarete et al., J. Polym. Sci. B: Polym. Phys. 2001, 39, 1721 and De Geus et al., Polym. Chem. 2010, 1, 525).

However, control over molecular weight and polydispersity index of the resulting polyester may be limited and more importantly the ring-opening polymerisation with enzymes is strongly limited by the applied temperature, because enzymes will typically not withstand higher reaction temperatures. In addition, the enzymes that can be used for ring-opening polymerisation of lactones are rather expensive.

In view of the limitations of enzymatic ring-opening polymerisation, attempts have been made to find suitable alternative metal-mediated ring-opening polymerisation processes. Such processes are particularly attractive, because they allow a high level of control over the polymer molecular weight, the molecular weight distribution, copolymer composition and topology and end-groups by using a nucleophilic initiator. It is commonly agreed that the driving force behind the ring-opening polymerisation of lactones is the release of ring-strain in the transition from the cyclic ester to the polyester chain or, in thermodynamic terms, by the negative change of enthalpy. Consequently, as the ring-strain decreases with increasing ring size of the cyclic ester so does the reactivity in metal-mediated ring-opening polymerisation. Experimentally, this was shown by Duda in a comparative study of the ring-opening polymerisation of various size lactones using zinc octoate/butyl alcohol as a catalyst/initiator (Duda et al., Macromolecules 2002, 35, 4266). While the relative rates of polymerisation were found to be 2500 and 330 for the six-membered (β-valerolactone) and seven-membered (ε-caprolactone) lactones, respectively, the reaction rates of the 12-17 membered lactones were only around 1. In view of the desire to provide a suitable catalyst for metal-mediated ring-opening polymerisation of lactones capable of achieving similar conversions and molecular weights as reported for enzymatic ring-opening polymerisation and further to obtain good thermo-stability of metal-mediated ring-opening polymerisation and versatility of metal-mediated ring-opening polymerisation regarding control of molecular weight, molecular weight distribution and end-groups, WO 2012/065711 discloses a process for preparing a polyester, comprising providing an optionally substituted lactone having a ring size of from 6 to 40 carbon atoms; and subjecting said lactone to metal mediated ring-opening polymerisation using as catalyst a compound according to general formula (I):

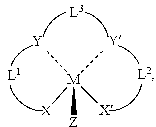

wherein

M is selected from the group consisting of Al, Ti, V, Cr, Mn and Co;

X and X′ are independently a heteroatom, preferably X and X′ are identical;

Y and Y′ are independently selected from the group consisting of O, N, S, P, C, Si, and B, preferably Y and Y′ are identical;

Z is selected from the group consisting of hydrogen, borohydrides, aluminium hydrides, carbyls, silyls, hydroxide, alkoxides, aryloxides, carboxylates, carbonates, carbamates, amines, thiolates, phosphides, and halides;

L1 and L2 are independently an organic ligand linking X and Y together and linking X′ and Y′ together, respectively, preferably L1 and L2 are identical; and

L3 is an optional organic ligand linking Y and Y′ together.

In view of the prior art, there remains a need in the art to provide one or more of the following: a further method for the ring-opening polymerisation of large ring size cyclic esters, in particular lactones; a method for the ring-opening polymerisation of cyclic esters, in particular lactones, which allows the preparation of high molecular weight polyesters having well controlled molecular weight and polydispersity; a method for the ring-opening polymerisation of cyclic esters, in particular lactones, that allows the preparation of star shaped polyesters or co-polyesters; a method for the ring-opening polymerisation of cyclic esters, in particular lactones, that allows the preparation of polyesters using catalysts that are biocompatible and/or can be used in applications where the polyester material is in contact with food; or a method for the ring-opening polymerisation of cyclic esters, in particular lactones, wherein the amount of catalyst is reduced to a minimum.

### SUMMARY

The present inventors have now found a further catalyst system that allows the controlled ring-opening polymerisation of cyclic esters, in particular lactones, having a relatively large ring size. To that extent the present invention is directed to a method for preparing a polyester comprising providing a first cyclic ester having a ring size of from 12-40 atoms and subjecting the first cyclic ester to ring-opening polymerisation by contacting the first cyclic ester with a catalyst of formula I

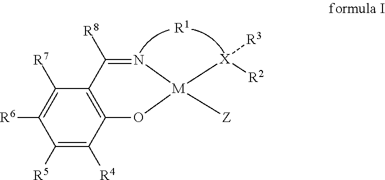

wherein

M is a metal and selected from the group consisting of group 2 metals and group 12 metals;

Z is selected from the group consisting of hydrogen, borohydrides, aluminium hydrides, carbyls, silyls, hydroxides, alkoxides, aryloxides, carboxylates, thiocarboxylates, dithiocarboxylates, carbonates, carbamates, guanidates, amides, thiolates, phosphides, hydrazonate, imide, cyanide, cyanate, thiocyanate, azide, nitro, siloxides and halides;

X is selected from the group consisting of O, N, S, and P;

R¹ is an organic linking moiety and has a chain length of at least one, preferably at least two atoms;

R² is an organic moiety selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, C₁₋₁₀ amine, C₁₋₁₀ nitro, C₁₋₁₀ cyano a halide (F, Cl, Br, I), and a 5- or 6 membered heterocycle containing from 1 to 4 heteroatoms selected from oxygen, sulfur, nitrogen, and phosphorous;

R³ is an optional organic moiety and may be the same or different as R²;

R⁴, R⁵, R⁶, R⁷ are organic moieties, may be the same or different and selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, _{C1-10} amine, C₁₋₁₀ nitro, C₁₋₁₀ cyano a halide (F, Cl, Br, I), and a 5- or 6 membered heterocycle containing from 1 to 4 heteroatoms selected from oxygen, sulfur, nitrogen, and phosphorous; and

R⁸ is an organic moiety selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, _{C1-10} amine, C₁₋₁₀ nitro, C₁₋₁₀ cyano a halide (F, Cl, Br, I), and a 5- or 6 membered heterocycle containing from 1 to 4 heteroatoms selected from oxygen, sulfur, nitrogen, and phosphorous.

### DESCRIPTION OF THE FIGURES

FIG. 1 shows a DSC plot for two copolymers prepared with a method according to the present invention.

FIG. 2 shows a DSC plot of CL/PDL random copolymers prepared with a method according to the present invention.

### DETAILED DESCRIPTION

The inventors found that the metal complex catalyst of formula (I) is capable of efficiently catalyzing the metal mediated ring-opening polymerisation of cyclic esters, in particular lactones, having a relatively large ring size, in a fashion yielding polymers with similar properties, such as polydispersity index and molecular weight than those obtainable by enzymatic ring-opening polymerisation. Furthermore, the polymerisation method was found to have good polymerisation kinetics, comparable or better than enzymatic ring-opening polymerisation of lactones. By proper selection of metal M a catalyst system can be obtained that is biocompatible approved and/or allows a reduction of total amount of catalyst to be used and/or allows star-shaped or other topology polymers to be obtained. Therefore, by employing the method some or all of the aforementioned objectives are met.

With respect to group Z:

the borohydride may be BH₄₋ₓRₓ wherein x is an integer from 0-3 and R is carbyl or alkoxide,

the aluminium hydrides may be AlH₄₋ₓRₓ, wherein x is an integer from 0-3, and R is carbyl or alkoxide,

the carbyl may be any hydrocarbon, —CR₃, —Ar (aryl), —CR═CR₂, —C≡CR, wherein R is hydrogen, optionally substituted alkyl, optionally substituted aryl,

the silyl may be —SiR₃, wherein R is hydrogen, optionally substituted alkyl, optionally substituted aryl,

the alkoxide may be —OR, wherein R is optionally substituted alkyl,

the carboxylate may be —OC(═O)R, wherein R is hydrogen, optionally substituted alkyl, optionally substituted aryl),

the thiocarboxylate may be —SC(═O)R, wherein R is hydrogen, optionally substituted alkyl, optionally substituted aryl,

the dithiocarboxylate may be —SC(═S)R, wherein R is hydrogen, optionally substituted alkyl, optionally substituted aryl,

the guanidinate may be (—N═C(R^{a})N(R^{b})R^{c} or N(R^{b})C(R^{a})═NR^{c}, wherein R^{a}, R^{b}, R^{c} is hydrogen, optionally substituted alkyl, optionally substituted aryl,

the carbonate may be —OC(═O)OR, wherein R is optionally substituted alkyl, optionally substituted aryl,

the carbamate may be —OC(═O)NR₂, wherein R is optionally substituted alkyl, optionally substituted aryl,

the amide may be —NR₂, wherein R is hydrogen, optionally substituted alkyl, optionally substituted aryl,

the thiolate may be —SR, wherein R is hydrogen, optionally substituted alkyl, optionally substituted aryl,

the phosphide may be —PR₂, wherein R is hydrogen, optionally substituted alkyl, optionally substituted aryl,

the hydrazonate may be (—N(R^{a})N═C(R^{b})R^{c}, where R^{a}, R^{b}, R^{c} is hydrogen, optionally substituted alkyl, optionally substituted aryl,

the imide may be (—N═C(R^{a})R^{b}, where R^{a}, R^{b} is hydrogen, optionally substituted alkyl, optionally substituted aryl.

The term “carbyl” as used herein is meant to refer to all types of hydrocarbons including alkyl, aryl, vinyl, and acetylene.

Substituent Z can inter alia be a borohydride or an aluminium hydride. Borohydrides (e.g. BH₄) and aluminium hydrides (e.g. AlH₄) are anionic species that bind via the hydrides. This may be illustrated as M(μ-H)₂AH₂ (M=as defined above, A=B or Al).

Preferably Z is a carbyl group having 1-4 carbon atoms, such as ethyl or methyl, propyl and butyl or Z is pentyl, hexyl, heptyl, n-octyl, or Z is an alkoxide group containing 1-20 carbon atoms, such as methoxide, ethoxide, or benzyloxide. If Z is a carbyl group having 1-4 carbon atoms then in use when activating the catalyst with for example an alcohol, the respective organic molecule is released from the reaction mixture in gaseous form leaving no residues. For example, if Z is ethyl, then upon activation of the catalyst with an alcohol, ethane is released and catalytically active metal alkoxide is formed.

Metal M is preferably selected from the group consisting of aluminium, calcium, zinc, and magnesium and is preferably magnesium, calcium, or zinc. The present inventors found that catalysts based on these metals allow high molecular weight polymers to be obtained and can be prepared relatively easily. In addition to that calcium, magnesium, and zinc metals are biocompatible. When the metals calcium, zinc, and magnesium are used a living catalyst system is obtained. With a living catalyst system is meant that the catalyst will keep active in the ring-opening polymerisation until it is either deactivated or until no more monomer is left in the reaction mixture. Catalyst deactivation may for example be carried out by adding acidic methanol to the reaction mixture. Other metals within group 2 or 12 may show similar behaviour as calcium, zinc and magnesium yet may be less favorable from an economic point of view, and/or may result in lower polymerisation rate and/or may also result in transesterification reactions. For example, the present inventors have found that a catalyst based on aluminium as the metal results in some transesterification reactions (in particular back-biting) which has the effect that some low molecular weight cyclic oligomers are produced. Moreover, any blocky copolymer will slowly be transformed into a more random type copolymer. Therefore, and strictly speaking, a catalyst based on aluminium cannot be considered as a living catalyst. Such catalyst system may nevertheless be referred to as a well-controlled catalyst system. R¹ of formula I is preferably a straight or branched aliphatic chain, or cyclic or aromatic moiety, that contains 1 to 30 carbon atoms, optionally containing 1 to 10 heteroatoms selected from N, O, F, Cl and Br. R¹ may be a saturated moiety. Particularly preferred are straight or branched saturated aliphatic chains having a chain length of 1 to 4, or 2 to 4, carbon atoms. R¹ preferably does not contain a heteroatom. R¹ may be (C₂H₄)—, (C₃H₆)—, —(C₄H₈)—. An example wherein R¹ is a cyclic moiety is cyclohexyl.

In a preferred embodiment of the method:

X is N,

R⁵, R⁷ and R⁸ are hydrogen, and/or

R⁴ and R⁶ are independently selected from hydrogen, methyl, ethyl, propyl, isopropyl, n-butyl, i-butyl, s-butyl, t-butyl, n-pentyl, i-pentyl, neopentyl, n-hexyl, 2,2 dimethylbutane, 2-methylpentane, 3-methylpentane, 2,3 dimethylbutane, cyclohexane, adamantyl, methoxide, ethoxide, (n-/t-)butoxide, aryloxide and halides.

In a further preferred embodiment of the method of the present invention:

R¹ is a [CH₂—CH₂]— linking moiety R² and R³ are hydrogen and/or

R⁵, R⁷ and R⁸ are hydrogen and/or

R⁴ and R⁶ are tert-butyl and/or

X is N and/or

Z is ethyl or N(Si—CH₃)₂.

In a specific embodiment the catalyst is selected from

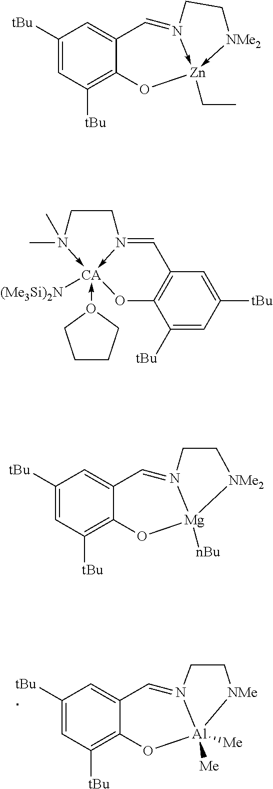

The mechanism and initiation of ring-opening polymerization is well known to the skilled person and is for instance described in “Handbook of Ring-opening Polymerization, 2009, Eds. Philippe Dubois, Olivier Coulembier, Jean-Marie Raquez, Wiley VCH, ISBN: 978 3 527 31953 4”.

An important aspect of the catalyst is that these catalysts show living/well-controlled behavior. Moreover, these catalysts are stable in the presence of an excess of protic chain transfer agents, which creates an immortal catalyst system allowing the production of multiple polymer chains per active site without loss of activity and while remaining perfect control over the molecular weight, PDI and polymer microstructure (random and block copolymers) as well as topology (linear, star-shaped (co-)polymers).

The first cyclic ester has a ring size from 12-40 atoms, preferably from 12 to 24 atoms. Preferably the first cyclic ester is a lactone. Preferably the atoms forming the ring, other than the oxygen of the ester, are carbon atoms. The first cyclic ester may be for example 11-undecalactone, 12-dodecalactone, 13-tridecalactone, 14-tetradecalactone, 15-pentadecalactone (or ω-pentadecalactone), globalide, 16-hexadecalactone, ambrettolide, 17-heptadecalactone, 18-octadecalactone, 19-nonadecalactone. Particularly preferred second cyclic esters are pentadecalactone, 18-octadecalactone, 12-pentadecen-15-olide (known as globalide) and 7-hexadecen-16-olide (known as ambrettolide) in view of their commercial availability and/or ease of manufacture and good reactivity. Preferably the second cyclic ester has only one ester functionality in the ring.

The term ring-size as used herein refers to the number of atoms that form the ring in the cyclic ester. For example caprolactone has a seven membered ring, i.e. a ring size of seven. The ring of caprolactone consists of six carbon atoms and one oxygen atom.

The method according to the invention may further comprise providing a second or further cyclic ester, preferably having a second ring size from 4-40 atoms, and wherein both the first and second cyclic ester are subjected to said ring-opening polymerisation. In other words, the method is not restricted to homopolymerisation of cyclic esters but may also be used to prepare copolymers by adding a second or further cyclic ester to the reaction.

The second (or further) cyclic ester may be a cyclic ester having a ring size from 4-11 atoms, such as from 4-8 atoms. Preferably the second or further cyclic ester is a lactone, which is a cyclic ester having a single ester group in the ring. Preferably the atoms forming the ring, other than the oxygen of the ester, are carbon atoms. Examples of the second or further cyclic ester include β-propiolactone, β-butyrolactone, 3-methyloxetan-2-one, γ-valerolactone, caprolactone, ε-caprolactone, ε-decalactone, 5,5-dimethyl-dihydro-furan-2-one, (S)-γ-hydroxymethyl-γ-butyrolactone, γ-octanoic lactone, γ-nonanoic lactone, δ-valerolactone, δ-hexalactone, δ-decalactone, δ-undecalactone, δ-dodecalactone, glycolide, lactide (L, D, meso), heptalactone, octalactone, nonalactone, decalactone. Preferably the second or further cyclic ester has only one ester functionality in the ring.

The second (or further) cyclic ester may also be a cyclic ester having a ring size from 12-40 atoms, such as from 12 to 24 atoms. The second or further cyclic ester is preferably a lactone. Preferably the atoms forming the ring, other than the oxygen of the ester, are carbon atoms. The second or further cyclic ester may be for example 11-undecalactone, 12-dodecalactone, 13-tridecalactone, 14-tetradecalactone, 15-pentadecalactone (or ω-pentadecalactone), globalide, 16-hexadecalactone, ambrettolide, 17-heptadecalactone, 18-octadecalactone, 19-nonadecalactone. Preferably the second cyclic ester has only one ester functionality in the ring.

The first and/or second and/or further cyclic esters, in particular where these are lactones, may be in any isomeric form and may further contain organic substituents on the ring that do not prevent the ring-opening polymerisation. Examples of such cyclic esters include 4-methyl caprolactone, 1,5-dioxepan-2-one (ether substituent at the 3 position), the lactone of ricinoleic acid (a 10-membered ring with a hexyl branched on the (co-1)-position) or the hydrogenated version of thereof, 13-hexyloxacyclotridecan-2-one (a macrocycle with a hexyl branch on the α-position), and the like.

It is further possible that the first and/or second and/or further cyclic ester comprise one or more unsaturations in the ring. Examples of such cyclic esters include 5-tetradecen-14-olide, 11-pentadecen-15-olide, 12-pentadecen-15-olide (also known as globalide), 7-hexadecen-16-olide (also known as ambrettolide), 9-hexadecen-16-olide.

The first and/or second cyclic ester may further have one or more heteroatoms in the ring, provided that such do not prevent the ring-opening polymerisation. Examples of such cyclic esters include 10-oxahexadecanolide, 11-oxahexadecanolide, 12-oxahexadecanolide, and 12-oxahexadecen-16-olide. Preferably however, the first and/or second and/or further cyclic esters do not contain heteroatoms in the ring.

An embodiment of the method wherein a second and/or further cyclic ester is subjected to ring-opening polymerisation may be carried out using a single step or “one pot” technique or by using a sequential feed polymerisation technique or sequential polymerisation technique.

The term “sequential polymerisation” as used herein should be understood to mean the sequential ring-opening polymerisation of the cyclic esters. In this polymerisation technique one cyclic ester is polymerised at a time and only after a first cyclic ester has been substantially converted to polymer then a second cyclic ester is added to the reaction. The sequential feed polymerisation method can be carried out by ring-opening polymerisation of the first cyclic ester followed by ring-opening polymerisation of the second or further cyclic ester, or by ring-opening polymerisation of the second or further cyclic ester followed by ring-opening polymerisation of the first cyclic ester. A sequential polymerisation technique is very different from a copolymerisation technique wherein all cyclic esters are added or are otherwise present during the reaction at the same time, such a technique possibly being referred to as a “1-pot”, “one step”, or “single feed” polymerisation technique.

The method is not restricted to any of these techniques and may even involve a hybrid technique involving the polymerisation of a first cyclic ester until a certain conversion, for example between 20% and 80%, is reached and then continued by addition of a second or further cyclic ester.

Preferably the method is carried out in one step.

In the method of the invention the molar ratio between the amount of cyclic ester and the catalyst is preferably in the range of 20:1-1000:1, preferably in the range of 40:1-750:1, more preferably in the range of 50:1-500:1.

Optionally the catalyst used in the method of the invention may be applied in combination with an initiator, preferably in about equimolar amount. Suitable initiators for the method include protic reagents such as alcohols, water, carboxylic acids, and amines. Such initiators are well known to the person skilled in the art and examples thereof can, for instance, be found in Clark et al., Chem. Commun. 2010, 46, 273-275 and references cited therein, which document is herewith incorporated by reference.

The use of multifunctional initiators (or chain transfer agents) is for example disclosed in Dong et al., Macromolecules 2001, 34, 4691 or Dong et al., Polymer 2001, 42, 6891 or Kumar et al, Macromolecules 2002, 35, 6835, or Zhao et al., Chem. Mater. 2003, 15, 2836 or Carnahan et al., J. Am. Chem. Soc. 2001, 123, 2905. In an embodiment where the ring-opening polymerisation is performed in the presence of an initiator, the molar ratio between initiator and catalyst is about 1:1, unless the reagent used as initiator is also used as chain transfer agent.

If the initiator is also used as chain transfer agent then the molar ratio between the cyclic esters and the initiator can be used as a tool for tuning the molecular weight of the polyester that is prepared according to the inventive method. To that extent the present inventors found that the molecular weight of the polymer increases almost linearly with an increasing cyclic ester to initiator ratio.

In an embodiment where the initiator is used as a chain transfer agent, then the initiator is added in excess with respect to the catalyst to produce more than one chain per active site. The amount of applied catalyst can be reduced in the presence of a chain transfer agent due to an increase in catalyst efficiency. If present, the molar amount of chain transfer agent will typically be in the range of 1-1000 times the molar amount of catalyst, preferably in the range of 10-100, more preferably 10-50 times the molar amount of catalyst. In this embodiment the monomer to catalyst ratio may be more than 1000:1 and can reach relatively high values, for example up to 1000000.

The ring-opening polymerisation reaction is preferably performed in an inert atmosphere, such as in a nitrogen atmosphere for the reason that the catalysts perform better under inert atmosphere and preferably in the absence of (significant amounts of) water.

If desired, the ring-opening polymerisation of the invention can be performed in the presence of a solvent, such as aliphatic or aromatic hydrocarbons (e.g. heptane, toluene), halogenated aliphatic or aromatic hydrocarbons (e.g. dichloromethane, bromobenzene), and ethers (e.g. diethyl ether). The solvent may be used to dissolve the cyclic esters and/or to increase the polymerisation kinetics and selectivity. The ring-opening polymerisation may however also be carried out in bulk monomer.

The molecular weight of the polyester prepared by the process of the invention may vary within wide limits and can be tuned to meet specific properties by selecting the molar ratio between the cyclic esters and the catalyst and, if applicable, the amount and type of chain transfer agent (or initiator).

Advantageously, the method of the invention is performed at relatively high process temperatures, at which enzymes used for enzymatic ring-opening polymerisation of lactones would normally degrade. Typically, the process of the invention can be performed at a temperature in the range of from 70-180° C., such as in the range of from 80-175° C., or in the range of from 90-150° C.

Since the amount of catalyst used in the process of the invention is relatively low, there is no direct need for separating the catalyst from the polymer product once prepared. However, should there be a need for separating the catalyst for whatever reason then this can be done for instance by precipitation of the polymer in a suitable solvent.

The polyester obtained with the method may have any desired molecular weight, from relatively low if a waxy material is desired or to relatively high values so as to obtain the desired mechanical properties or melt viscosity. Preferably the number average molecular weight (Mₙ) is at least 2000 gram/mol with a practical upper limit of for example 150000 g/mol. More preferable Mₙ is from 30000 to 100000 g/mol or 50000 to 80000 gram/mol.

A further aspect of the method is that it allows manufacture of polyesters having a relatively low polydispersity index, which preferably is at most 3. Polydispersity index, or PDI, as defined herein means the ratio of the weight average molecular weight and the number average molecular weight (M_{w}/Mᵣ). More preferably the PDI is from 1-3 or from 1-2.

The polyester obtainable by the method according to the present invention may be a linear polymer, a star type polymer, such as a Y-type branched polymer, an H-type branched polymer, and a comb type, or brush type, polymer.

A Y-type branched polymer is a polymer that has three branches connected to one another at a central point. Such type of polymer is a species of the more general term star type polymers.

An H-type branched polymer is a polymer that has four branches connected to one another from a central linking group (or bridge). Such type of polymer is a species of the more general term star type polymers. The bridge may be a short hydrocarbon chain, for example having a chain length of from two to six carbon atoms, from which the four branches extend.

A comb or brush type polymer is a polymer that has a linear molecular chain as a backbone (the base of the comb or brush) from which a multitude of branches (the teeth of the comb or brush) extend.

A star type polymer is a polymer that has a centre from which a multitude of branches extend. The centre may be a single atom or a small hydrocarbon.

The present inventors believe this flexibility in tuning the type of polymer is a strength of the method according to the present invention. The polymer type may be tuned by selecting the appropriate initiator (or chain transfer). For example if pentaerythritol is selected as the initiator then a star-type polymer may be formed having four branches.

The polyesters obtained with the method of the invention can be used in a wide variety of applications depending on their respective properties, such as number average molecular weight, polydispersity index, type, and respective amounts of first and/or second cyclic esters that were used in the method etc.

The polyesters may be used for the fabrication of fibers with high mechanical strength. In particular copolymers with high molecular weight and relatively low polydispersity index are suitable for this purpose.

The polyesters may further be used for biomedical applications. In this respect it is highly advantageous that the degradability of the polyesters can be tuned by the incorporation of a comonomer. For example it is known that (co)polymers from lactones having relatively low ring size are more biodegradable than lactones with a high ring size.

So, by tuning the composition (i.e. choice and amount of first and second lactones) of the copolymer the desired biodegradability can be obtained. The more random the copolymer, the more uniform this biodegradability will be.

Examples of biomedical applications include screws (such as for bone), scaffolding, sutures, drug delivery devices, etc.

The polyesters may further be used in polymer compositions further comprising other polymer materials such as for example polyesters, polycarbonates, polyamides and polyolefins.

The invention will now be further illustrated by means of the following Examples and the Figures, which are not intended to be limitative in any way.

### EXAMPLES

All solvents and reagents were purchased from commercial sources unless stated otherwise. p-Xylene (99.9%) was dried over sodium and fractionally distilled under nitrogen and degassed prior to use. Hexadecanol, pentadecalactone, ε-decalactone, ambrettolide, ε-caprolactone, and β-butyrolactone were freshly distilled from CaH₂ under nitrogen prior to use. Toluene was passed through purification columns and degassed before use.

¹H NMR and ¹³C NMR spectra were recorded at room temperature in CDCl₃ using a Varian Mercury Vx spectrometer operating at frequencies of 400 MHz and 100.62 MHz for ¹H and ¹³C, respectively. For ¹H NMR experiments, the spectral width was 6402.0 Hz, acquisition time 1.998 s and the number of recorded scans equal to 64. ¹³C NMR spectra were recorded with a spectral width of 24154.6 Hz, an acquisition time of 1.300 s, and 256 scans. Chemical shifts are reported in ppm vs. tetramethylsilane (TMS) and were determined by reference to TMS.

High Temperature Size Exclusion Chromatography (HT-SEC) was performed at 160° C. using a Polymer Laboratories PLXT-20 Rapid GPC Polymer Analysis System (refractive index detector and viscosity detector) with 3 PLgel Olexis (300×7.5 mm, Polymer Laboratories) columns in series. 1,2,4-Trichlorobenzene was used as eluent at a flow rate of 1 mL·min⁻¹. The molecular weights were calculated with respect to polyethylene standards (Polymer Laboratories). A Polymer Laboratories PL XT-220 robotic sample handling system was used as autosampler.

Melting temperatures (Tₘ) were measured by differential scanning calorimetry (DSC) using a DSC Q100 from TA Instruments. The measurements were carried out at a heating and cooling rate of 10° C.·min⁻¹ from −60° C. to 130° C. The transitions were deduced from the second heating and cooling curves. First and second runs were recorded after cooling down to ca. 20° C. The melting temperatures reported correspond to the melting peaks in the second runs.

Homo-Polymerisation Conditions

In a glove box cyclic ester (lactone) monomer, catalyst and an equimolar amount of alcohol (R—OH) were placed in a small glass crimp cap vial. Dry toluene was added and the vial was capped. The reaction mixture was removed from the glove box and stirred for given time at 100° C. For all reactions, an aliquot of crude polymer was withdrawn at the end of the polymerisation and dissolved in CDCl₃ in order to determine the monomer conversion by ¹H NMR spectroscopy. The reaction was then stopped by cooling the mixture, removal of toluene under vacuum, and addition of excess methanol (˜5 mL) to precipitate the polymer. The produced polymers were isolated and dried under vacuum at room temperature for at least 18 hours and characterized inter alia by high temperature size-exclusion chromatography (HT-SEC), differential scanning calorimetry (DSC), and ¹H, ¹³C nuclear magnetic resonance spectroscopy (NMR).

Co-Polymerisation Conditions

In a glove box first and second cyclic esters (lactones), catalyst, and an equimolar amount (to catalyst) of alcohol (ROH) were placed simultaneously in a small glass crimp cap vial. The vial was capped, removed from the glove box, and stirred for given time at 100° C. (1 to 18 h). Next, an aliquot of crude polymer was removed from the vial for determination of monomer conversion. The copolymer was then precipitated in THF, dried under vacuum for 18 h, and characterized inter alia by high temperature size-exclusion chromatography (HT-SEC), differential scanning calorimetry (DSC), and ¹H, ¹³C nuclear magnetic resonance spectroscopy (NMR).

Co-Polymerisation Conditions for Block Copolymerisation

First cyclic ester (lactone) monomer and toluene (or directly in bulk conditions) were transferred into a glass crimp cap vial under inert nitrogen atmosphere in a glove box. An amount of alcohol (e.g. BnOH) was added to the mixture and the vial was then capped and reaction was carried out for predetermined reaction time at 100° C. At the end of the reaction time, an aliquot was taken for analysis. Based on the analysis an amount of second cyclic ester (lactone) monomer was then added to the vial under inert conditions after which the vial was sealed again and reacted further at 100° C. for a predetermined reaction time. At the end of this second reaction time an aliquot was removed and dissolved in CDCl₃ for NMR and the mixture was quenched by acidic methanol and the precipitated polymer was filtered, washed with methanol several times, and dried under vacuum for 24 h before further characterization.

Catalyst Preparation

Catalysts as used in the method may be prepared using procedures known in the art. Examples of such methods can be found in Cameron et al., J. Chem. Soc., Dalton Trans. 2002, 3, 415 and/or WO 2004/081020 and/or Troesch et al., Anorg. Allg. Chem 2004, 630, 2031-2034 and/or Chamberlain et al., J. Am. Chem. Soc. 2001, 123, 3229 and/or Colesand et al., Eur. J. Inorg. Chem. 2004, 2662 and/or Darensbourg, D. J.; Choi, W.; Richers, C. P. Macromolecules 2007, 40, 3521.

Catalyst 1

A first catalyst was prepared following the scheme 1.

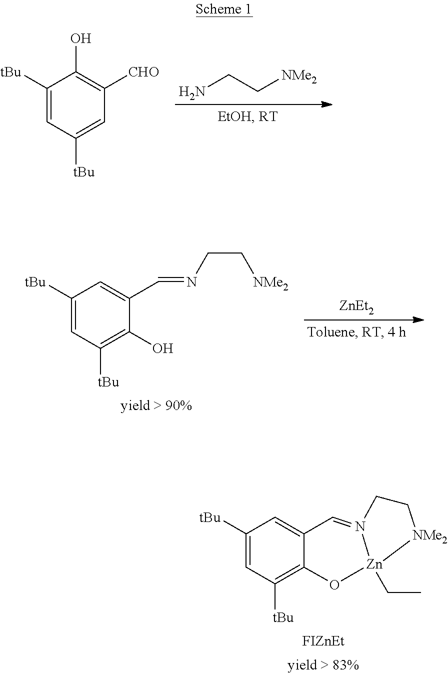

A solution of ZnEt₂ (1.71 mL of 1.1 M solution in hexane, 1.88 mmol) in toluene (10 mL) was added to a solution of (imino phenolate) pro-ligand {ONN}H (0.52 g, 1.71 mmol) in toluene (10 mL) at 20° C. The reaction was carried out for 24 h at room temperature after which volatiles were removed under vacuum. The residue was washed with cold petroleum ether (2×10 mL) and yielded Catalyst 1 in the form of a yellow powder (0.56 mg, 83° A)).

¹H NMR (400 MHz, CD₂Cl₂, 298 K): δ 0.17 (q, J=7.9 Hz, 2H, Zn—CH₂), 1.20 (t, J=8.1 Hz, 3H, Zn—CH₂CH₃), 1.27 (s, 9H, t-Bu), 1.43 (s, 9H, t-Bu), 2.37 (s, 6H, N(CH₃)₂), 2.60 (t, J=6.3 Hz, 2H, NCH₂CH₂NMe₂), 3.67 (t, J=6.3 Hz, 2H, NCH₂CH₂NMe₂), 6.91 (s, 1HAr), 7.33 (s, 1HAr), 8.15 (s, 1H, CH═N).

¹³C{¹H} NMR (75 MHz, C₆D₆, 298 K): δ 12.40 (Zn—CH₂), 29.06 (Zn—CH₂CH₃), 31.13 (C(CH₃)₃), 33.61 (C(CH₃)₃), 45.92 (N(CH₃)₂), 55.64 (NCH₂CH₂NMe₂), 60.53 (NCH₂CH₂NMe₂), 127.85, 128.61, 137.96, 140.89 (C_{A}), 168.75 (C═N).

Catalyst 2

A second catalyst was prepared using a similar procedure as for Catalyst 1 and following scheme 2.

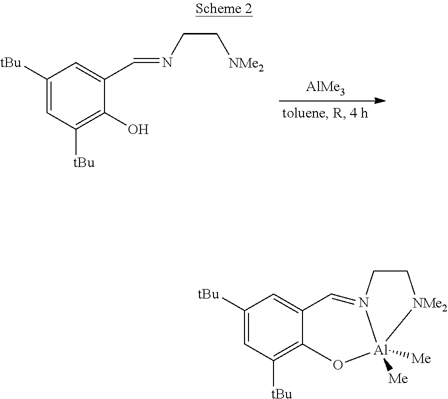

Catalyst 2 was prepared using a similar procedure as for preparation of Catalyst 1. A solution of AlMe₃ (1.25 mL of a 1.5 M solution in heptane, 1.88 mmol) was reacted with pro-ligand {ONN}H (0.56 g, 1.84 mmol) in toluene (10 mL), at room temperature for 24 hours and afforded after work-up Catalyst 2 as a white powder (0.57 g, 86%).

¹H NMR (400 MHz, C₆D₆, 298 K): δ −0.52 (s, 6H, Al(CH₃)₂), 1.06 (s, 9H, tBu), 1.40 (s, 9H, tBu), 1.62 (s, 6H, N(CH₃)₂), 1.84 (t, J=6.3 Hz, 2H, NCH₂CH₂NMe2), 2.64 (s, 2H, NCH₂CH₂NMe2), 6.56 (s, 1H, H_{Ar}), 6.91 (s, 1H, H_{Ar}), 8.02 (s, 1H, CH═N).

¹³C{¹H} NMR (100 MHz, C₆D₆, 298 K): δ −8.23 (Al(CH₃)₂), 29.92 (C(CH₃)₃), 31.94 (C(CH₃)₃), 35.60 (C(CH₃)₃), 36.58 (C(CH₃)₃), 42.76 N(CH₃)₂), 54.10 (NHCH₂CH₂N), 60.53 (NCH₂CH₂NMe₂), 125.56, 127.60, 134.12, 142.15 (C_{Ar}), 172.34 (C═N).

Catalyst 3

A third catalyst was prepared following scheme 3.

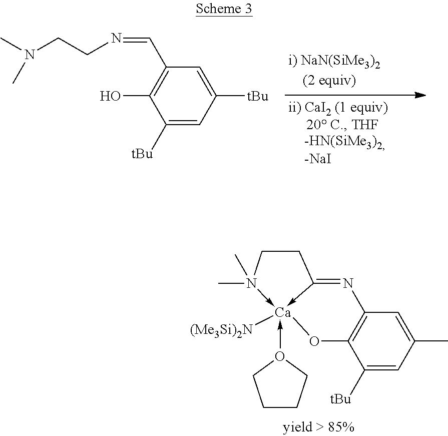

Catalyst 3 was prepared by dissolving pro-ligand {ONN}H (0.64 g, 2.10 mmol) and NaN(SiMe₃)₂ (0.77 g, 4.21 mmol) dissolved in 10 ml of THF. After stirring at room temperature for 6 h, the mixture was added to CaI₂ (0.62 g, 2.11 mmol) in THF (5 mL). The mixture was then stirred for 24 h at room temperature. The formed precipitate was removed by filtration and washed with THF (2×10 mL). The THF phases were combined and the THF (solvent) was removed under vacuum, yielding an orange residue which was then washed with petroleum ether (5×2 mL) and dried under vacuum, to give Catalyst 3 in the form of a yellow powder (1.02 g, 85%).

¹H NMR (400 MHz, CD₂Cl₂, 298 K): δ 0.04 (5, 18H, Si(CH₃)₃), 1.34 (s, 9H, C(CH₃)₃), 1.43 (s, 9H, C(CH₃)₃), 1.56 (s, 6H, N(CH₃)₂), 1.74 (m, 4H, β-CH₂THF), 1.94 (t, J=6.3 Hz, 2H, NCH₂CH₂NMe2), 2.64 (s, 2H, NCH₂CH₂NMe2), 6.56 (s, 1H, H_{Ar}), 3.61 (m, 4H, α-CH₂THF), 6.70 (s, 1H, H_{Ar}), 6.91 (s, 1H, H_{Ar}), 8.10 (s, 1H, CH═N).

¹³C{¹H} NMR (100 MHz, CD₂Cl₂, 298 K): δ 2.12 (Si(CH₃)₃), 25.43 (β-CH₂THF), 29.14 (C(CH₃)₃), 31.41 (C(CH₃)₃), 33.66 (C(CH₃)₃), 35.27 (C(CH₃)₃), 42.76 N(CH₃)₂), 54.10 (NHCH₂CH₂N), 60.53 (NCH₂CH₂NMe₂), 125.56, 127.60, 134.12, 142.15 (C_{Ar}), 167,79 (CO in Ar), 172.34 (C═N).

### Experiment 1

### Homopolymerisation

Table 1 summarises homopolymerisation experiments that were performed by the present inventors. Experiments were carried out using Catalyst 1, Catalyst 2, and Catalyst 3 and the cyclic ester monomers were penta-decalactone (PDL), ambretollide (Amb) and globalide (Glob). The alcohol ROH was BnOH. The cyclic ester (monomer) conversion was determined using ¹H NMR on the α-methylene hydrogen of the lactones. TOF stands for Turn Over Frequency and it is the ratio of the conversion and time. [mol/l]₀ means the concentration in mol per liter of the monomer prior to the polymerisation reaction. The term [Mon]/[M]/ROH means the molar ratio of monomer to metal of the catalyst to alcohol prior to start of the polymerisation reaction.

TABLE 1

| | | Monomer | [Mon]/ | Time | Conv. | TOF | Mn | |
|---|---|---|---|---|---|---|---|---|
| No. | Cat. | [mol/l]₀ | [M]/ROH | [h] | [%] | [%/h] | [kg/mol] | PDI |
| 1 | 1 | PDL 1.4 | 100/1/1 | 1.5 | 76 | 51 | 10.3 | 1.6 |
| | | (toluene) | | | | | | |
| 2 | 1 | PDL 3.8 | 100/1/1 | 1.5 | 90 | 60 | 17.8 | 1.6 |
| | | (bulk) | | | | | | |
| 3 | 1 | PDL 3.8 | 100/1/0.5 | 1.5 | 53 | 35 | 38.2 | 1.6 |
| | | (bulk) | | | | | | |
| 4 | 1 | Amb 3.8 | 100/1/1 | 1.5 | 95 | 63 | — | |
| | | (bulk) | | | | | | |
| 5 | 1 | Glob 3.8 | 100/1/1 | 1.5 | 99 | 66 | 7.6 | 1.5 |
| | | (bulk) | | | | | | |
| 6 | 2 | PDL 3.8 | 100/1/1 | 1.5 | 65 | 43 | 18.6 | 1.9 |
| | | (bulk) | | | | | | |
| 7 | 2 | PDL 3.8 | 100/1/0.5 | 1.5 | 53 | 35 | — | |
| | | (bulk) | | | | | | |
| 8 | 2 | Amb 3.8 | 100/1/1 | 1.5 | 99 | 66 | 19.9 | 1.6 |
| | | (bulk) | | | | | | |
| 9 | 2 | Glob 3.8 | 100/1/1 | 1.5 | 99 | 66 | 21.5 | 1.7 |
| | | (bulk) | | | | | | |
| 10 | 3 | PDL 3.8 | 100/1/1 | 0.5 | 75 | 150 | 28.5 | 1.7 |
| | | (bulk) | | | | | | |
| 11 | 3 | PDL 3.8 | 100/1/0 | 0.5 | 45 | 90 | 35.9 | 1.6 |
| | | (bulk) | | | | | | |
| 12 | 3 | PDL 1.4 | 200/1/1 | 0.5 | 69 | 138 | — | |
| | | (toluene) | | | | | | |

Further experiments with Catalyst 1 and Catalyst 2 were carried out using PDL as monomer. These experiments are summarised in Table 2 below. Polymerisation was carried out as disclosed herein. The term [BnOH] means the molar amount of benzyl alcohol per mol of catalyst that is used for the polymerisation.

TABLE 2

| | | | | Time [h] | | | |
|---|---|---|---|---|---|---|---|
| | | | | 4 | | 24 | |
| | | | Monomer | Mn | | Mn | |
| # | Cat. | [BnOH] | [Mol/l]₀ | [kg/mol] | PDI | [kg/mol] | PDI |
| 13 | 1 | 0.5 | 3.8 | 7.6 | 1.8 | 38.2 | 1.7 |
| | | | (bulk) | | | | |
| 14 | 1 | 1.0 | 3.8 | 9.1 | 1.6 | 17.8 | 1.8 |
| | | | (bulk) | | | | |
| 15 | 1 | 5.0 | 3.8 | 3.7 | 1.2 | 6.7 | 1.4 |
| | | | (bulk) | | | | |
| 16 | 1 | 0.5 | 1.4 | 35.0 | 1.7 | 69.7 | 1.8 |
| | | | (toluene) | | | | |
| 17 | 2 | 0.5 | 3.8 | 53.4 | 1.9 | 48.7 | 2.1 |
| | | | (bulk) | | | | |
| 18 | 2 | 2.0 | 3.8 | 21.9 | 1.8 | 19.6 | 1.8 |
| | | | (bulk) | | | | |
| 19 | 2 | 2.0 | 1.4 | 22.4 | 1.9 | 25.8 | 1.7 |
| | | | (toluene) | | | | |

The results from table 2 show that upon increasing [BnOH] the obtained molecular weight of the polymer (PPDL) decreases. This is ascribed to the living or at least well-controlled nature of the catalyst and the fact that the benzyl alcohol acts as a chain transfer agent. This result further suggests that the catalyst metallic centers are stable and the ligand is not displaced under those conditions (excess of free alcohol). Without willing to be bound to it, the present inventors believe that this can be explained by fast reversible exchange between the growing polymer (PPDL) chains and the free alcohol or hydroxyl terminated polymers chains during the polymerisation process. This property of the catalytic system (i.e. the catalyst together with the alcohol) can therefore be used to minimize the amount of the catalysts and contribute to the limitation of the contamination of the final polymer by the metallic residue.

Table 2 also shows that the polydispersity index of the obtained polymer (PPDL) is relatively low and apart from sample 17 less than 2. Table 2 further shows that aluminium based Catalyst 2 will not result in the same degree of increase in molecular weight when comparing the polymers obtained after 4 hours and 24 hours respectively. The present inventors attribute this finding to transesterification reactions catalysed by the aluminium metal centers.

### Experiment 2

### Sequential Feed Co-Polymerisation of PDL and CL

PDL monomer and toluene were transferred into a vial under inert nitrogen atmosphere in a glove box. Catalyst 1 and an equimolar amount (with respect to the catalyst) of BnOH was added to the mixture and the vial was then capped and placed in oil bath at 100° C. for a predetermined reaction time. At the end of the reaction period, an aliquot was taken for analysis and the calculated ratio of caprolacton (CL) monomer was added, the sealed vial was then placed for an additional predetermined time at 100° C. In Experiment 2 the CL/PDL molar ratio was 2:1. At the end, an aliquot was removed and dissolved in CDCl₃ for NMR and the mixture was quenched by acidic methanol and the precipitated polymer was filtered, washed with methanol several times, and dried under vacuum for 24 h before characterization.

### Experiment 3

### Sequential Feed Co-Polymerisation of PDL and CL

Experiment 3 was carried out similar to Experiment 2, but with catalyst 3 as the catalyst.

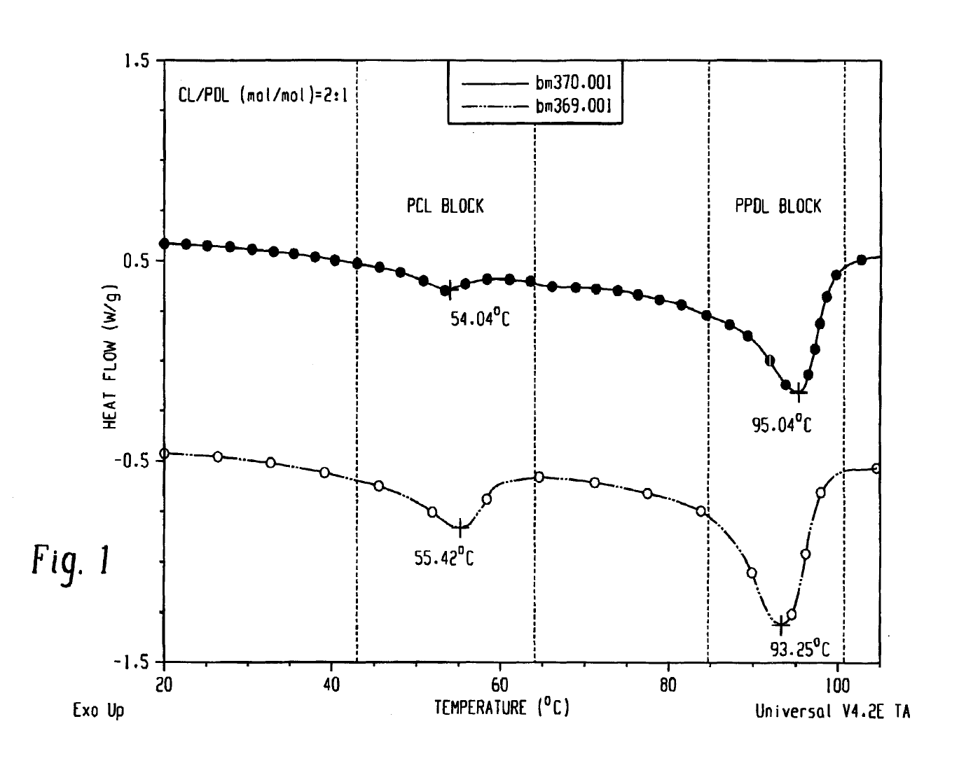

DSC plots of the polymers prepared in Experiments 2 and 3 are shown in FIG. 1. The upper curve corresponds to Experiment 2 and the lower curve corresponds to Experiment 3. Both DSC curves show two endothermic parts with two distinct melting temperatures corresponding to block polycaprolactone (PCL) with a melting temperature of about 55° C. and PPDL with a melting temperature of about 94° C. The present inventors found that the (sequential) copolymerisation of CL and PDL catalyzed by Catalyst 1 or Catalyst 3 occurs without transesterification side reactions, since after 18 hours at 100° C., the blocky structure was still maintained and no redistribution of the monomers in the copolymer backbone had taken place. To confirm this finding, a mixture of block poly(PDL-b-CL) copolymer produced using Catalyst 1 and a transesterification catalyst (TBD/BnOH (1% w/w)) was stirred for 18 hours and samples were taken at set time intervals (2, 7 and 18 h) and analyzed by DSC. The blocky copolymer structure indeed gradually transformed into a completely random copolymer with a single melting point between the melting points of PCL and PPDL.

The block character of the poly(PDL-co-CL) copolymer obtained by the sequential feed is further evidenced by the presence of two overlapping triplets in ¹H NMR spectrum, each of said triplets corresponding to the protons of α-methylene groups of CL and PDL units in the PCL and PPDL blocks respectively.

### Experiment 4

### One Pot Co-Polymerisation of CL and PDL

In a glove box, PDL, CL, Catalyst 1, and an equimolar amount (to catalyst) of BnOH were placed simultaneously in a small glass crimp cap vial. The vial was capped, removed from the glove box, and heated at 100° C. for the given time (1 to 18 h). For all reactions, an aliquot of crude polymer was removed for the determination of copolymerisation conversion. The copolymer was then precipitated in THF, dried under vacuum for 18 h, and characterized by size-exclusion chromatography (SEC), differential scanning calorimetry (DSC), and ¹H, ¹³C nuclear magnetic resonance spectroscopy (NMR).

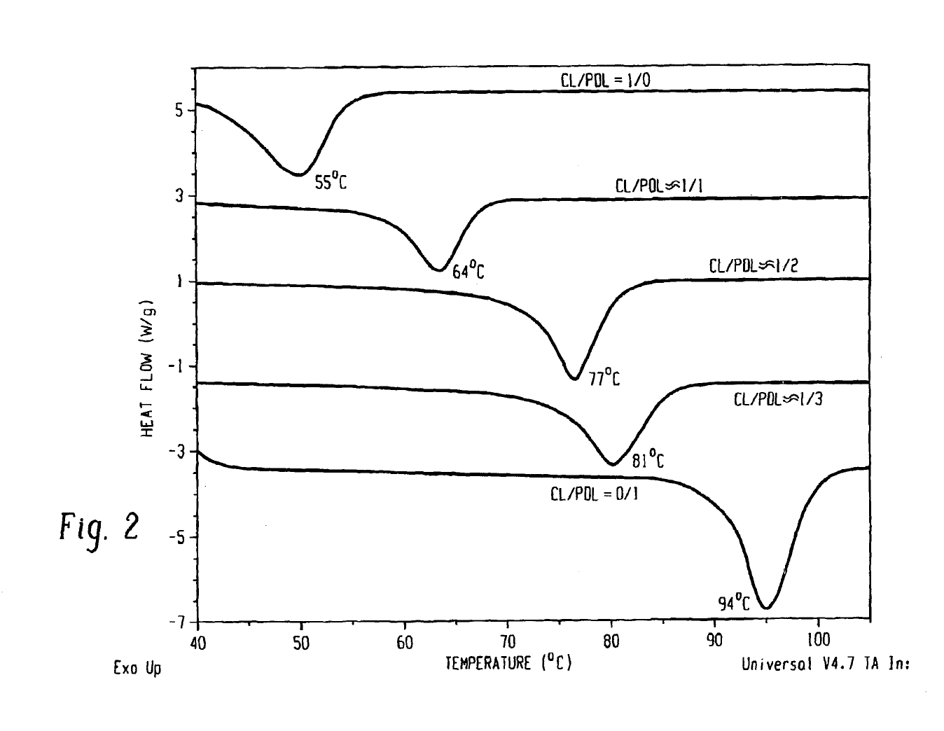

FIG. 2 shows a DSC plot of three copolymers prepared with three different monomer molar ratio's CL/PDL. FIG. 2 further shows the a DSC plot of PDL (bottom) and PCL (top) homopolymers. The DSC plots only show a single melting peak indicative for the formation of random copolymers rather than block (or blocky) copolymers. Depending on the CL/PDL ratio the melting peak will be either closer to the melting peak of PDL homopolymer or PCL homopolymer. The random character of the poly(PDL-co-CL) copolymer obtained by one-pot synthesis is further evidenced by the presence of only one triplet corresponding to the protons of α-methylene groups of both CL and PDL units in the ¹H NMR spectrum.

### Experiment 5

### Co-Polymer of Pentadecalactone and ε-Decalactone (eDL)

Contrary to expectations of the present inventors it was found that PDL and eDL when copolymerized using a one-pot synthesis yielded blocky copolymers. Without willing to be strictly bound to it, the present inventors attribute this finding the steric hindrance that the butyl branch of eDL imposes on the insertion of PDL units during the polymerisation. The steric hindrance and the conformation of the eDL and PDL have the effect of difference in reactivity of the two monomers causing favorable polymerisation of eDL. Experiments were carried out using Catalyst 1 using similar experimental conditions as in Experiment 4. The reaction was carried out at 100° C., the ratio of Catalyst 1 to BnOH was 1, and the combined concentration of PDL and eDL was 4.16 mold.

Table 3 summarises the experiments. [M] designates molar equivalents of monomer, i.e. cyclic ester, [Cat] refers designates molar equivalents of catalyst, [BnOH] designates molar equivalents of BnOH, [PDL] designates molar equivalents of PDL, [eDL] designates molar equivalents of eDL. Tr means reaction time. The conversion was determined from ¹H NMR spectra and expressed in percentage. The number average and weight average molecular weight was determined using HT-SEC in TCB against polyethylene standards. The PDI (polydispersity index) is the ratio of M_{w}/Mₙ. Experiments for samples #1-5 were carried out in bulk at 100° C., whereas experiments for samples #6-16 were carried out in solvent at a temperature of 100° C.

TABLE 3

| | mol ratio | mol ratio | | Conversion | | |
|---|---|---|---|---|---|---|
| | [M]/[Cat]/ | [PDL]/ | Tr | [PDL]/ | Mₙ | |
| # | [BnOH] | [eDL] | [h] | [eDL] | [kg/mol] | PDI |
| 1 | 500/1/0.5 | 1/0 | 5 | 54/— | 73.0 | 2.3 |
| 2 | 500/1/0.5 | 0.7/0.3 | 14 | 25/100 | 15.5 | 1.9 |
| 3 | 500/1/0.5 | 1/1/ | 24 | 64/100 | 21.8 | 2.3 |
| 4 | 500/1/0.5 | 0.3/0.7 | 24 | 44/100 | 18.6 | 1.9 |
| 5 | 500/1/0.5 | 0/1 | 3 | —/100 | 13.8 | 1.3 |
| 6 | 100/1/1 | 1/1 | 1 | 18/88 | 6.6 | 1.22 |
| 7 | 100/1/1 | 1/1 | 2 | 24/100 | 7.8 | 1.55 |
| 8 | 100/1/1 | 1/1 | 3 | 45/100 | 10.9 | 1.84 |
| 9 | 100/1/1 | 1/1 | 5 | 78/100 | 14.5 | 2.08 |
| 10 | 100/1/1 | 1/1 | 8 | 81/100 | 13.4 | 2.00 |
| 11 | 100/1/1 | 1/1 | 14 | 94/100 | 15.8 | 2.07 |
| 12 | 100/1/1 | 1/1 | 24 | 100/100 | 15.2 | 2.02 |
| 13 | 100/1/1 | 1/0 | 3.5 | 95/— | 13.5 | 2.19 |
| 14 | 100/1/1 | 0/1 | 3.5 | —/100 | 3.6 | 1.13 |
| 15 | 100/1/1 | 0.7/0.3 | 3.5 | 44/100 | 6.6 | 1.70 |
| 16 | 100/1/1 | 0.3/0.7 | 3.5 | 36/100 | 5.6 | 1.79 |

From samples #6 to #13 it can be observed that eDL is completely converted within about 2 hours, whereas at that point PDL has only converted to 24%. The obtained polymer was found to be a blocky co-polymer which was confirmed with analytical techniques such as DSC, NMR and MALDI-ToF-MS.

Interestingly the homo-polymerisation of PDL reaches a conversion of about 95% after 3.5 hours, whereas during copolymerisation with eDL this conversion is only reached after about 14 hours. These results support the findings of the present inventors as set out above for this Experiment 5.

### Experiment 6

### Co-polymer of PDL and ε-decalactone (eDL)

PDL and eDL where copolymerized in bulk at 100° C. using a one-pot synthesis. The reaction was carried out at 100° C., the ratio of Catalyst 3 to BnOH was 1, the amount of eDI was 0.354 g, the amount of PDL was 0.500 g, the amount of Catalyst 3 0.0239 g. Table 4 summarises the experiments:

TABLE 4

| | | | | Conv. | Conv. | | |
|---|---|---|---|---|---|---|---|
| | Time | PDL | eDL | PDL | eDL | M_{n, exp} | |
| # | (h) | (mol %) | (mol %) | (%) | (%) | (kg/mol) | PDI |
| 1 | 1 | 100 | 0 | 91 | — | 9.8 | 2.3 |
| 2 | 2 | 100 | 0 | 94 | — | 10 | 2.1 |
| 3 | 3 | 100 | 0 | 97 | — | 9.9 | 2.2 |
| 4 | 4 | 100 | 0 | 98 | — | 9.9 | 2.2 |
| 5 | 5 | 100 | 0 | 99 | — | 10.2 | 2.2 |
| 6 | 24 | 100 | 0 | 99 | — | 9.3 | 2.3 |
| 7 | 1 | 50 | 50 | 19 | 100 | 3.1 | 1.7 |
| 8 | 2 | 50 | 50 | 64 | 100 | 4.2 | 2.0 |
| 9 | 3 | 50 | 50 | 67 | 100 | 4.6 | 2.1 |
| 10 | 4 | 50 | 50 | 93 | 100 | 6.1 | 2.0 |
| 11 | 5 | 50 | 50 | 93 | 100 | 6.2 | 2.1 |

Samples #1 to #6 show homo-polymerisation of PDL. The conversion already reaches a high level after one hour (91%). Samples #2-#6 shows that PDL conversion gradually increases to nearly 100% and that molecular weight and polydispersity remain at a more or less stable level.

In summary, a method for preparing a polyester comprising providing a first cyclic ester having a ring size of from 12-40 atoms, preferably wherein the first cyclic ester is a lactone and preferably selected from the group consisting of pentadecalactone, ambrettolide, globalide, and 18-octadecalactone, optionally further comprising providing a second cyclic ester having a second ring size from 4-40, preferably from 4-11 atoms, and subjecting the first cyclic ester and optional second cyclic ester to ring-opening polymerisation by contacting the first cyclic ester with a catalyst of formula I

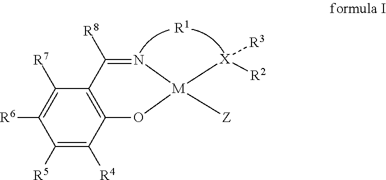

wherein

M is a metal and selected from the group consisting of group 2 metals and group 12 metals, preferably wherein metal M is selected from the group consisting of Ca, Zn and Mg and is preferably Ca or Zn

Z is selected from the group consisting of hydrogen, borohydrides, aluminium hydrides, carbyls, silyls, hydroxides, alkoxides, aryloxides, carboxylates, thiocarboxylates, dithiocarboxylates, carbonates, carbamates, guanidates, amides, thiolates, phosphides, hydrazonate, imide, cyanide, cyanate, thiocyanate, azide, nitro, siloxides and halides, preferably wherein Z is ethyl or N(Si—CH₃)₂;

X is selected from the group consisting of O, N, S and P, preferably wherein X is N;

R¹ is an organic linking moiety and has a chain length of at least one, preferably at least two atoms, preferably wherein R₁ is a straight or branched aliphatic chain, or cyclic or aromatic moiety, that contains 1 to 30 carbon atoms, optionally containing 1 to 10 heteroatoms selected from N, O, F, Cl and Br, preferably wherein R¹ is a [CH₂—CH₂]-linking moiety;

R² is an organic moiety selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, _{C1-10} amine, C₁₋₁₀ nitro, C₁₋₁₀ cyano a halide (F, Cl, Br, I), and a 5- or 6 membered heterocycle containing from 1 to 4 heteroatoms selected from oxygen, sulfur, nitrogen, and phosphorous;

R³ is an optional organic moiety and may be the same or different as R², and preferably R² and R³ are hydrogen;

R⁴, R⁵, R⁶, R⁷ are organic moieties, may be the same or different and selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, _{C1-10} amine, C₁₋₁₀ nitro, C₁₋₁₀ cyano a halide (F, Cl, Br, I), and a 5- or 6 membered heterocycle containing from 1 to 4 heteroatoms selected from oxygen, sulfur, nitrogen, and phosphorous, preferably wherein R⁴ and R⁶ are independently selected from hydrogen, methyl, ethyl, propyl, isopropyl, n-butyl, i-butyl, s-butyl, t-butyl, n-pentyl, i-pentyl, neopentyl, n-hexyl, 2,2 dimethylbutane, 2-methylpentane, 3-methylpentane, 2,3 dimethylbutane, cyclohexane, adamantyl, methoxide, ethoxide, (n-/t-)butoxide, aryloxide, and halides, preferably wherein R⁵, R⁷ and R⁸ are hydrogen; and

R⁸ is an organic moiety selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, _{C1-10} amine, C₁₋₁₀ nitro, C₁₋₁₀ cyano a halide (F, Cl, Br, I), and a 5- or 6 membered heterocycle containing from 1 to 4 heteroatoms selected from oxygen, sulfur, nitrogen, and phosphorous, preferably wherein R⁴ and R⁶ are tert-butyl; and

specifically wherein the catalyst is selected from the group consisting of

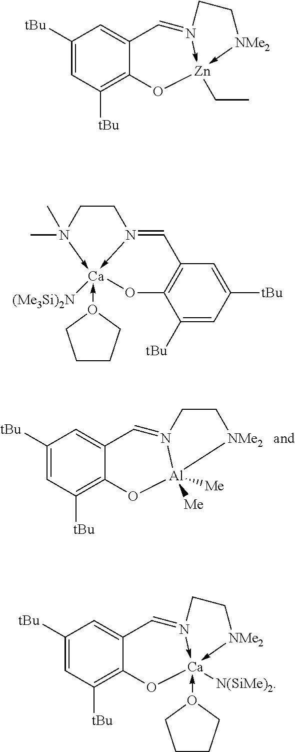

In any of the foregoing embodiments, one or more of the following conditions can apply: the polymerisation is carried out in one step; the polyester is a random co-polyester; the polymerisation is carried out in the presence of an initiator consisting of an organic compound having at least two, preferably at least three hydroxyl groups; the polymerisation is carried out a temperature in the range of from 70-180° C., preferably in the range from 80-175° C., more preferably in the range from 90-150° C.; and the polyester is a linear polyester, a star type polyester or a comb-type polyester.

The terms “a” and “an” and “the” herein do not denote a limitation of quantity, and are to be construed to cover both the singular and the plural, unless otherwise indicated herein or clearly contradicted by context. “Or” means “and/or” unless clearly indicated otherwise. All ranges disclosed herein are inclusive of the endpoints, and the endpoints are independently combinable with each other. “Combination” is inclusive of blends, mixtures, alloys, reaction products, and the like. Furthermore, the terms “first,” “second,” and the like, herein do not denote any order, quantity, or importance, but rather are used to distinguish one element from another.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

I/we claim:

1. A method for preparing a polyester comprising providing a first cyclic ester having a ring size of from 12-40 atoms and subjecting the first cyclic ester to ring-opening polymerisation by contacting the first cyclic ester with a catalyst of formula I 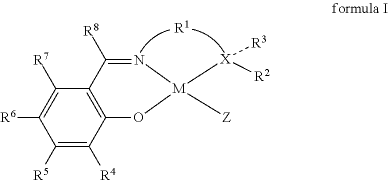
wherein
M is a metal and selected from the group consisting of group 2 metals, aluminum, and group 12 metals;
Z is selected from the group consisting of hydrogen, borohydrides, aluminium hydrides, carbyls, silyls, hydroxides, alkoxides, aryloxides, carboxylates, thiocarboxylates, dithiocarboxylates, carbonates, carbamates, guanidates, amides, thiolates, phosphides, hydrazonate, imide, cyanide, cyanate, thiocyanate, azide, nitro, siloxides and halides;
X is selected from the group consisting of O, N, S, and P;
R¹ is an organic linking moiety and has a chain length of at least one, preferably at least two atoms;
R² is an organic moiety selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, C₁₋₁₀ amine, C₁₋₁₀ nitro, C₁₋₁₀ cyano a halide (F, Cl, Br, I), and a 5- or 6 membered heterocycle containing from 1 to 4 heteroatoms selected from oxygen, sulfur, nitrogen, and phosphorous;
R³ is an optional organic moiety and may be the same or different as R²;
R⁴, R⁵, R⁶, R⁷ are organic moieties, may be the same or different and selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, _{C1-10} amine, C₁₋₁₀ nitro, C₁₋₁₀ cyano, a halide selected from the group consisting of F, Cl, Br, and I, and a 5- or 6 membered heterocycle containing from 1 to 4 heteroatoms selected from oxygen, sulfur, nitrogen, and phosphorous; and
R⁸ is an organic moiety selected from the group consisting of hydrogen, C₁₋₁₀ alkyl, silyl, C₁₋₆ alkoxy, C₃₋₈ cycloalkyl, C₃₋₈ cycloalkoxy, aryl, aryloxy, C₁₋₁₀ amine, C₁₋₁₀ nitro, C₁₋₁₀ cyano, a halide selected from the group consisting of F, Cl, Br, and I, and a 5- or 6 membered heterocycle containing from 1 to 4 heteroatoms selected from oxygen, sulfur, nitrogen, and phosphorous.

2. The method according to claim 1 wherein metal M is selected from the group consisting of Ca, Zn, Al, and Mg.

3. The method according to claim 1 wherein R¹ is a straight or branched aliphatic chain, or cyclic or aromatic moiety, that contains 1 to 30 carbon atoms, optionally containing 1 to 10 heteroatoms selected from N, O, F, Cl and Br.

4. The method according to claim 1 wherein
X is N,
R⁵, R⁷ and R⁸ are hydrogen, and/or
R⁴ and R⁶ are independently selected from hydrogen, methyl, ethyl, propyl, isopropyl, n-butyl, i-butyl, s-butyl, t-butyl, n-pentyl, i-pentyl, neopentyl, n-hexyl, 2,2-dimethylbutane, 2-methylpentane, 3-methylpentane, 2,3-dimethylbutane, cyclohexane, adamantyl, methoxide, ethoxide, n-butoxide, t-butoxide, aryloxide, and halides.

5. The method according to claim 1 wherein
R¹ is a —[CH₂—CH₂]— linking moiety,
R² and R³ are hydrogen, and/or
R⁵, R⁷ and R⁸ are hydrogen, and/or
R⁴ and R⁶ are tert-butyl, and/or
X is N, and/or
Z is ethyl or N(Si—CH₃)₂.

6. The method according to claim 1 wherein the catalyst is selected from the group consisting of

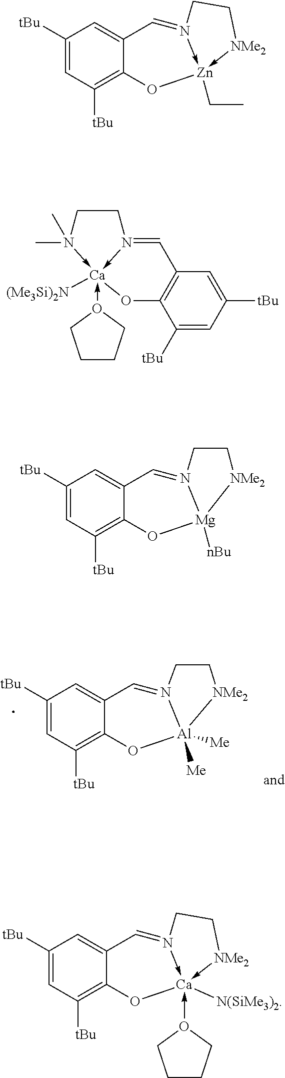

7. The method according to claim 1 wherein the first cyclic ester is a lactone.

8. The method according to claim 1 any one or more of claims 1-7 further comprising providing a second cyclic ester having a second ring size from 4-40, and wherein both the first and second cyclic ester are subjected to said ring-opening polymerisation.

9. The method according to claim 8 wherein the polymerisation is carried out in one step.

10. The method according to claim 8 wherein the polyester is a random co-polyester.

11. The method according to claim 1 wherein the polymerisation is carried out in the presence of an initiator consisting of an organic compound having at least two hydroxyl groups.

12. The method according to claim 1 wherein the polymerisation is carried out a temperature in the range of from 70-180° C.

13. The method according to claim 1 wherein the polyester is a linear polyester, a star type polyester, or a comb-type polyester.

14. The method according to claim 2 wherein the metal M is Ca or Zn.

15. The method according to claim 7 wherein the first cyclic ester is selected from the group consisting of pentadecalactone, ambrettolide, globalide, and 18-octadecalactone

16. The method according to claim 8 wherein the second cyclic ester has a second ring size from 4-11 carbon atoms.

17. The method according to claim 11 wherein the polymerisation is carried out in the presence of an initiator consisting of an organic compound having at least three hydroxyl groups.

18. The method according to claim 11 wherein the polymerisation is carried out a temperature in the range from 80-175° C.

19. The method according to claim 11 wherein the polymerisation is carried out a temperature in the range from 90-150° C.

20. The method according to claim 1, wherein
metal M is selected from the group consisting of Al, Ca, Zn, and Mg;
X is N,
Z is ethyl or N(Si—CH₃)₂,
R⁵, R⁷ and R⁸ are hydrogen, and/or
R⁴ and R⁶ are independently selected from hydrogen, methyl, ethyl, propyl, isopropyl, n-butyl, i-butyl, s-butyl, t-butyl, n-pentyl, i-pentyl, neopentyl, n-hexyl, 2,2-dimethylbutane, 2-methylpentane, 3-methylpentane, 2,3-dimethylbutane, cyclohexane, adamantyl, methoxide, ethoxide, n-butoxide, t-butoxide, aryloxide, and halides.
